(19) United States
(12) Patent Application Publication
(10) Pub. No.: US 2006/0070584 A1
(43) Pub. Date: Apr. 6, 2006

(54) Leash for multiple pets

(76) Inventor: Viki T.C.M. Larouche, Oakville (CA)

Correspondence Address: MARKS & CLERK, 1075 NORTH SERVICE ROAD WEST, SUITE 203, OAKVILLE, ON, L6M 2G2, CA

(21) Appl. No.: 11/242,031

(22) Filed: Oct. 4, 2005

Related U.S. Application Data
(60) Provisional application No. 60/614,981, filed on Oct. 4, 2004.

(51) Int. Cl. A01K 27/00

(52) U.S. Cl. 119/795

(57) ABSTRACT

An improved leash for multiple pets is provided which includes a retractable leash having a retractable cord attached to a first leash, and a second leash assembly which can be connected to the retractable cord using a lightweight, releasable ring such as a split-ring key ring, or by a loop form in the second leash assembly. The second leash assembly can be easily attached to any retractable leash having a retractable cord, and eliminates the problems caused by the pulley systems used on prior art devices. A safer, multiple pet leash is provided which can be more easily created from traditional retractable leashes is provided.

### CROSS REFERENCE TO RELATED APPLICATIONS

This application claims the benefit of priority under 35 U.S.C. § 119(e) to U.S. Provisional Application Ser. No. 60/614981, filed on Oct. 4, 2005, the entirety of which is hereby incorporated by reference.

### FIELD OF THE INVENTION

The present invention relates to the field of pet leashes, and in particular, relates to a pet leash for walking multiple pets simultaneously.

### BACKGROUND OF THE INVENTION

Many people own dogs and in fact own multiple dogs. One of the niceties and/or necessities in owning such an animal is taking the dogs for a walk. This usually entails the use of a leash, and when multiple dogs are owned, the owner must resort to either using more than one conventional leash or use a leash which is specifically designed to handle more than one dog.

A variety of inventions have been created to facilitate the walking of multiple dogs using a leash which has only one handle. The advantages of having a single handle for multiple dogs is chronicled in various patents such as, for example, Parker, U.S. Pat. No. 5,632,234, Tozawa U.S. Pat No. 5,702,848, Crowe et. al. U.S. Pat. No. 4,879,972, Gish U.S. Pat. No. 5,852,988, and Imes U.S. Pat. No. 6,474,270, as well as others.

Parker, in '234, clearly describes the deficiencies with the previous designs available up until then, and provides an improved design that addresses some of those shortcomings. Although the '234 patent resolved some of the problems the previous designs failed to correct, the '234 patent had limitations of its own.

In particular, as the '234 patent states, the previous designs failed to take into account the common situation when two pets wished to roam in different directions. Further, the '234 patent identified the need to design a leash to account for the different activity levels, strength and sizes of dogs. Nonetheless, the '234 patent failed to address an active small dog being walked with a larger active dog.

The '234 patent relied on a single elongated pet lead in which the two animals would be attached to either end. Unfortunately, when the first animal would move in a direction opposite the second animal, the second animal would be pulled in the direction of the first animal. Consequently, when the elongated pet lead became taunt the larger or more stronger dog would tend to drag the smaller dog in the direction of the larger animal.

In addition, the '234 design does not account for the situation where the user wishes to keep the pets on a short leash, for their own safety, or the like. Specifically, the '234 patent has a static, uncontrolled length between the pets, and thereby allows one or more of the pets to roam into dangerous situations.

In Imes '270, the authors attempted to resolve this issue by creating a point of flexibility for each leash, that was provided by a leash retracting means that is held and manipulated by the user. In '270, a first pet is attached to a first leash fitted to the end of an elongated, retractable, narrow cord. A second pet is attached to a short second leash having a pulley at one end that is fitted around the narrow cord, and thus can ride along the narrow cord as the second pet moved towards or away from the first pet. If necessary, additional narrow cord can be released from the narrow cord storage housing as either of the first or second pet moved.

As a result, each pet would be able to move independently away from the user and/or the other pet(s) attached to the disclosed leash design since the narrow cord would provide the necessary slack as it was pulled from its storage housing.

Additionally, to provide closer control over the pets, the narrow cord could be retracted so that each pet will be more closely controlled by the user since they would now be contained at the end of a relatively short leash.

While this design alleviates some of the problems associated with the walking of multiple pets, further improvement to this leash system would be desirable.

For example, removal of the second leash of '270 can be difficult. As described in '270, removal of one leash (for walking a single pet) would be accomplished by releasing the narrow cord from the first leash, pulling the cord through the pulley of the second leash, and then reattaching the cord to the first leash. The operation would have to be repeated in reverse in order to reattach the second leash to the narrow cord, or to add additional leashes.

This operation of pulling or feeding the cord through the pulley and reattaching the first leash can be time consuming, and may not be practical for all leash designs. In particular, it should be noted that most commercially available retractable leashes are provided with the narrow cord being essentially permanently attached to the first leash. As such, adding or removing a second leash is not an option on these leashes, and in order to provide the function described in the '270 patent, a complete leash “system” having a specific retractable leash must be purchased.

Further, the pulley system requires that a rotating pulley be used that must be maintained over the life of the leash in order to avoid sticking or binding of the pulley as it rotates. Additionally, a poorly fitted pulley would allow the cord to leave the surface of the pulley and bind against the side of the pulley housing. This might damage the pulley and/or the narrow cord requiring premature replacement of either component.

Also, the pulley could stick or bind as debris (such as grass, twigs, sticks, dirt, etc.) pass through the pulley as the narrow cord retracts and extends when the pets are moving through various terrains.

Finally, on some models of retractable leashes, a nylon strap is used in place of the narrow cord. On these models, the use of a pulley for traversing the length of the nylon strap is not practical.

To overcome these difficulties, it would be advantageous to provide a new and improved multiple pet leash design which allows each pet greater freedom to roam independently of one another, while allowing the owner to adjust or control this freedom.

Further, it would be advantageous to provide such a system wherein a second, or more, leash can be more easily added or removed from the multiple leash system.

This is achieved in the present invention by providing a multiple leash design wherein the second (or a further) leash is attached to the narrow cord by using a releasable ring.

### SUMMARY OF THE INVENTION

Accordingly, it is a principal advantage of the present invention to provide a leash for use with multiple pets wherein a second leash is attached to a retractable leash assembly, wherein the second leash is attached using a releasable ring.

The advantages set out hereinabove, as well as other objects and goals inherent thereto, are at least partially or fully provided by the multiple leash arrangement of the present invention, as set out herein below.

Accordingly, in one aspect, the present invention provides a leash for multiple pets comprising:
a) a retractable leash assembly including:
   i) a body having an aperture;
   ii) a handle;
   iii) a retractable cord having two ends;
   iv) one end of the retractable cord connected through the aperture of the body to a retracting means for the retracting and releasing of the retractable cord contained within the body, and the other end of the retractable cord connected to a first leash connector;
   v) a first leash having two ends wherein one end is connected to said first leash connector, and the other end is connected to a first fastener;
b) an attachable leash assembly including:
   i) a second leash having two ends;
   ii) a second fastener attached to one end of said second leash; and
   iii) a slidable ring structure for attaching said attachable leash assembly to said retractable cord, preferably comprising a slidable ring or a releasable ring, attached to the opposite end of said second leash, and which slidable ring has an opening through which said first leash can be inserted, or wherein said releasable ring is adapted to be releasably connected to said retractable cord of said retractable leash by temporarily moving said releasable ring to an open position to allow said retractable cord to be positioned within an opening in said releasable ring, and subsequently moving said releasable ring to a closed position, whereby said slidable ring structure is free to slide on said retractable cord.

In a further aspect, the present invention also provides an attachable leash assembly for attachment to the retractable cord of a retractable leash, comprising:
i) a leash having two ends;
ii) a fastener attached to one end of said leash; and
iii) a slidable ring structure for attaching said attachable leash assembly to said retractable cord, preferably comprising a slidable ring or a releasable ring, attached to the opposite end of said second leash, and which slidable ring has an opening through which said first leash can be inserted, or wherein said releasable ring is adapted to be releasably connected to said retractable cord of said retractable leash by temporarily moving said releasable ring to an open position to allow said retractable cord to be positioned within an opening in said releasable ring, and subsequently moving said releasable ring to a closed position, whereby said slidable ring structure is free to slide on said retractable cord, and wherein said slidable ring structure is not a snaphook.

Preferably, the releasable ring is a split-ring key ring, or a spring ring clasp, and said slidable ring is formed by creating a loop of said leash at one end of the leash.

### DETAILED DESCRIPTION OF THE INVENTION

In the present application, the term “pet” refers to an animal that can be walked using a lease. Most commonly, the pet will be a dog, although other types of pets may be walked using the leash of the present invention. As such, while dogs are specifically mentioned herein, the skilled artisan will be well aware that the leash might be used for any suitable pet.

Retractable leashes are commonly available that comprise a leash that automatically retracts and releases. An example of a suitable retractable leash is commercially available as a product known as Flexi-2™ available from Flexi USA Inc.

Other commercially available products exist which have the same basic characteristics as the Flexi-2™, and any suitable leash which has a retracting means for retracting and releasing a leash may be used. Similar devices as the Flexi-2™ are described in such patents as U.S. Pat. Nos. 3,693,596, 3,937,418 and 4,562,792.

In general, however, the retractable leash is comprised of a retractable cord whose one end is attached to a retracting means for retracting and releasing the retractable cord and which is contained within a body for storage of the retractable leash. The retractable cord can be any suitable shape or size, but preferably is a circular, rope-like cord having, for example a wire core, or can be a generally flat strap made of nylon, or the like. The retracting means is generally comprised of a spool and a spring means attached to the spool to force the spool to rotated in a manner which coils the retractable cord. However, other variations may exist.

The other end of the retractable cord is attached to a first leash connector which connects the retractable cord to a first end of a first leash. The first leash is made of any suitable material for use as a pet leash, including leather, cotton, nylon or polyester cord, or the like, but preferably the first leash is a nylon strap. The opposite (or second) end of the first leash is attached to a first fastener; the type of which is commonly used to connect a leash to a dog collar, and which is commonly referred to as a “snaphook”. A snaphook is typically “hook” shaped with a spring-loaded portion that can be retracted to form an opening and then closed to enlosed a pet leash, or the like.

Preferably, the retracting means not only automatically retracts the leash but also permits the leash to be released when one or more of the dogs exerts tension on the retractable cord.

The second part of the current embodiment is a second leash assembly for attachment to the retractable cord of a retractable leash, wherein the second leash assembly comprises a second leash, having a first end to which is attached a fastener (such as a snaphook fastener), and a second end to which is attached a slidable ring structure such as a slidable ring, or a releasable ring. The second leash can optionally be made of any of the same materials as the first leash, but preferably, both the first and second leashes are both made of a nylon strap.

The slidable ring can be formed merely by looping an end of the leash material to form a loop or ring. The leash material can be held in this shape by clamping, or otherwise connecting the end of the leash to itself, as shown hereinbelow. The loop or ring formed is preferably sized so as to allow the first leash to be inserted into this loop so that the loop can be fed to be in contact with the retractable cord. As such, the slidable ring can slide on the retractable cord.

Preferably, the second leash is fabricated of a material which will slide on the retractable cord without doing any significant damage. For example, the slidable ring can be fabricated of a plastic coated wire cord so that said plastic coated material can slide on the retractable cord.

The releasable ring is a small, lightweight device which can be fitted to the end of the leash and which has a central opening in which the retractable cord can be placed. The releasable ring is equipped to have a moveable section that can be temporarily moved from a open position which allows the easy insertion of the cord within the central opening, to a closed position for keeping the retractable cord within the opening of the ring.

This can include, for example, releasable rings having a threaded section that can be opened by un-threading a locking section of the ring, or by having a two-part ring with a hinge and a releasable locking system for holding the ring in a ring shape. Preferably, however, the releasable ring also has a spring-biasing means to maintain the releasable ring in a closed position, but which has a section that can be easily moved to an open position wherein the retractable cord can be inserted or removed from the centre area of the releasable ring.

In one preferred embodiment, the releasable ring can be a “split-ring” key ring having a coil or spiral of a resilient material such as steel, for example. These key rings can be easily fitted over the retractable cord by feeding the retractable cord through a “gap” or “slot” temporarily opened between the material coils. After threading the retractable cord through the slot, the opening in key ring coils can be released so as to close the gap or slot, and thus, the retractable cord is positioned, and held, within the centre of the releasable ring.

With this arrangement the retractable cord is free to move within the centre of the releasable ring, and as such, the key ring is free to slide along the length of the retractable cord. An important advantage of this embodiment is the elimination of the need for a pulley, and as such, eliminates the need for repair and/or replacement of a damaged pulley assembly. Also, retractable cords of any size or shape can be used without the need for a pulley assembly. Further, this arrangement permits the second leash, or any additional leashes, to be easily attached to the retractable cord of any retractable leashes.

In another preferred form of a releasable rings, the releasable ring is a spring ring clasp of the type which is generally circular in shape and having a spring loaded section that can be moved, using for example, an optional projection of the spring loaded section, to an open position where a retractable cord can be inserted into the open, centre area of the clasp. This section might be moved at an angle to the ring, or might be retracted into the ring structure.

Further, the releasable ring might be a snaphook as previously described with respect to the first fastener, although, for reasons described herein, the use of a snaphook of the size and shape commonly used on leashes, as the releasable ring, is not preferred. Numerous other types of releasable rings might also be used, including devices such as “lobster” hooks or the like.

The releasable ring will have a central opening larger than the retractable cord, and thus permit the ring to easily slide along the retractable cord with little or no damage to the retractable cord. The central opening of the ring is, however, preferably smaller in size than the first leash connector which is located between the retractable cord and the first leash, and thus the ring is prevented from sliding onto the first leash.

The releasable ring and the retractable cord-feed aperture in the retractable cord storage housing, will also be preferably sized so as to prevent the ring from entering the storage housing as the retractable cord is retracted. As such, the ring is preferably larger than the narrow-cord-feed aperture in the storage housing.

As such, the releasable ring is free to slide along the retractable cord, but preferably cannot traverse the first leash connector, and preferably does not enter the storage housing (to any great extent). It should be noted, however, that the storage housing might be adapted to at least partially receive, and/or retain the releasable ring.

It should also be noted that one additional advantage of the split-ring key ring, or a spring ring clasp, in the practice of the present invention, are their light weight. Pulley assemblies and the fasteners typically used to attach a leash to a pet collar, such as snaphooks, are typically heavier in weight, and can be a danger to the pets as this weighted object freely moves back and forth along the retractable cord. As such, the lower weight of the split ring key ring or spring ring clasp is less likely to cause injury to the pet, while still allowing the pet to freely move along the retractable cord. As such, the releasable ring preferably has a weight of less than 5 grams, and more preferably less than 3 grams.

Clearly, however, the releasable ring, or more generally, the slidable ring structure, should have sufficient structural strength to ensure that the second leash is not pulled off of the retractable cord, or the like.

The invention is used by attaching a second leash assembly to a retractable leash by either sliding the retractable cord of the retractable leash through the releasable ring, so that the retractable cord is held within the opening of the releasable ring, or by sliding the first leash through the slidable ring. The first fastener of the leash is attached to the collar of one dog, and the second fastener on the second leash is connected to the collar of another dog. The dogs, irrespective of their size, strength or activity levels roam in different directions. As the dogs begin to exert tension on their respective nylon straps, the tension is minimized by the release of the retractable cord from the retractable leash. Only when the retractable cord is completely released by the retractable leash may the dogs have a direct effect on one another.

However, the owner has the ability to change the length over which the dogs may roam by retracting the retractable cord into the body of the retractable leash. This owner thus has control over the freedom of the animals within seconds. This protects the animals and the owner while allowing the owner to permit the dogs to roam more freely when the space permits.

The current embodiment permits the dog attached to the second fastener to run the length of the retractable cord without hindrance so long as this dog does not exert any tension on the retractable cord. Further, should the dog attached to the second fastener exert tension on the leash, additional retractable cord can be provided from the releasable leash storage area, in a manner similar to the situation where additional retractable cord is released by having the first dog exert tension on the retractable leash.

By permitting the release of the retractable cord by the retracting means for the retracting and releasing of the retractable cord, when the dog attached to the second fastener exerts tension on the retractable cord, the dog attached to the first fastener does not feel any appreciable pull.

Accordingly, one object of the present invention is to provide a multiple pet leash whose various leashes automatically self adjusts in such a way to minimize the influence of one pet on another.

Another object of the present invention is to provide a multiple pet leash whose various leashes automatically self adjusts to allow greater roaming by one or more animals.

Another object of the present invention is to provide a multiple pet leash wherein a second or additional leash can be easily and readily attached or removed from the retractable cord of a releasable leash.

There has thus been outlined, rather broadly, the more important features of the invention in order that the detailed description thereof that follows may be better understood, and in order that the present contribution to the art may be better appreciated. However, there are additional features of the invention that will be described hereinafter and which will form the subject matter of the claims appended hereto.

### BRIEF DESCRIPTION OF THE DRAWINGS

Embodiments of this invention will now be described by way of example only in association with the accompanying drawings in which:

FIG. 1 is a representative drawing of a multiple leash system as described herein;

FIG. 2 is a perspective drawing of a second leash component for attachment to a retractable cord of a retractable leash;

FIG. 3 is an enlarged view of the split ring design at one end of the second leash, after attachment to the retractable cord;

FIG. 4 is an enlarged view of one type of spring ring clasp design at one end of the second leash after attachment to the retractable cord;

FIG. 5 is an enlarged view of a second type of spring ring clasp design at one end of the second leash after attachment to the retractable cord; and

FIG. 6 is a perspective drawing of a second embodiment of a second leash component.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention.

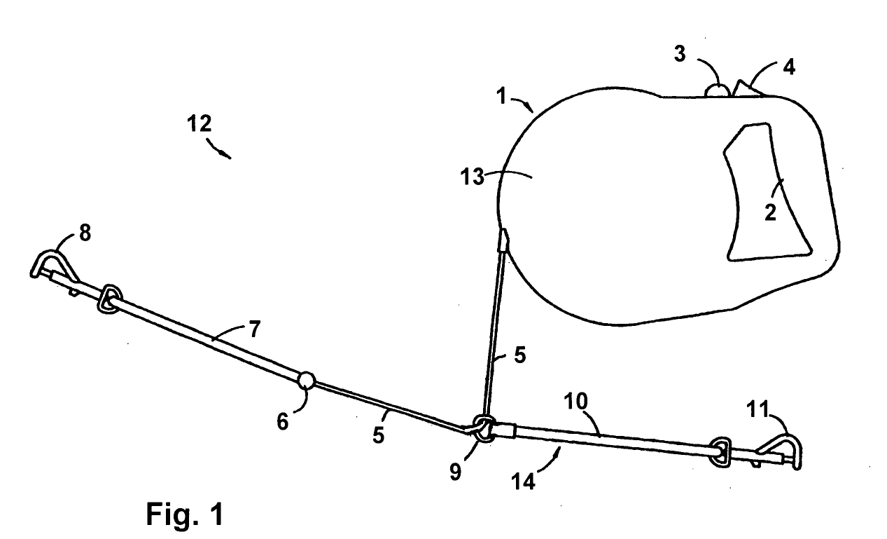

Referring to FIG. 1, a side view of a leash for multiple pets 12 is shown having a retractable leash I with a body 13, a handle section 2, a cord lock 3, and a retractable cord brake 4. Contained with the body 13 is a retracting means for retracting and releasing a circular cord 5 (acting as a retractable cord) having two ends. The circular cord 5 can be any suitable length but the preferred embodiment contemplates between fifteen and twenty-five feet. One end of the circular cord 5 is placed through a small aperture on the body 13 and is attached to the retracting means. The other end of the circular cord 5 is attached to a first leash connector 6. The connector 6 is attached to one end of a first nylon strap 7 having two ends. The opposite end of the first nylon strap 7 is attached to a snaphook, acting as a first fastener, 8 which is suitable for releaseable attachment to a pet collar.

A second leash 14 is comprised of a second nylon strap 10 having two ends. A second snaphook, acting as a second fastener 11, which is suitable for releasable attachment to a pet collar, is attached to one end of the second nylon strap. In this embodiment, a split-ring key ring 9 is attached to the other end of the second nylon strap 10, and acts as a releasable ring. The circular cord 5 passes through the key ring 9 such that the circular cord 5 can easily slide through the centre of key ring 9.

It should be noted that nylon straps 7, 10 may be any length but in the preferred embodiment, each strap preferably has a length of between 0.2 to 2 metres, and more preferably, has a length of between 0.3 and 0.6 metres. Further, it is preferred that the length of the straps would be equal.

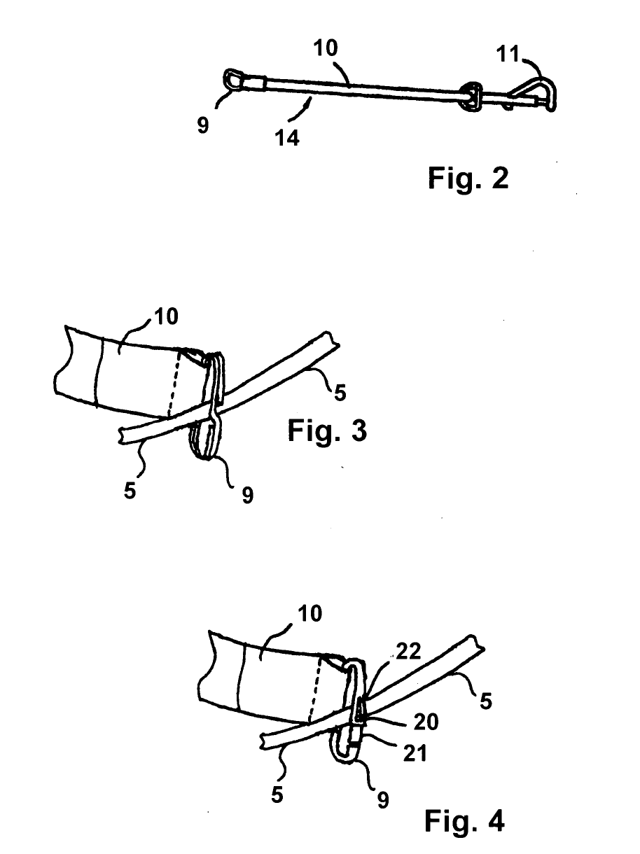

In FIG. 2, a second leash 14 is shown having a nylon strap 10, a snaphook acting as a fastener 11, and a split-ring key ring 9 which is adapted to be attached to the circular cord of a retractable pet leash. It should be noted that one or more of these second leashes 14 can be attached to circular cord 5 using each of their rings 9.

In FIG. 3, details of the split-ring key ring 9 are shown wherein the coils of the ring 9 can be temporarily separated to allow circular cord 5 to be fed from outside of the ring, into the centre of ring 9. Once circular cord 5 has passed through the coils of ring 9, the coils can be allowed to return to their normal position and thus prevent circular cord 5 from leaving the centre of ring 9.

In FIG. 4, details of the use of a spring ring clasp 19 are shown wherein ring clasp 19 is used in place of key ring 9. Ring clasp 19 has a projection 20 that is attached to a spring loaded section 21 which can be retracted in groove 22 so as to provide an opening for circular cord 5 to be inserted into the centre of ring clasp 19. Spring loaded section 21 is normally held in a position where this opening is closed, and thus circular cord 5 is held within the centre of ring clasp 19.

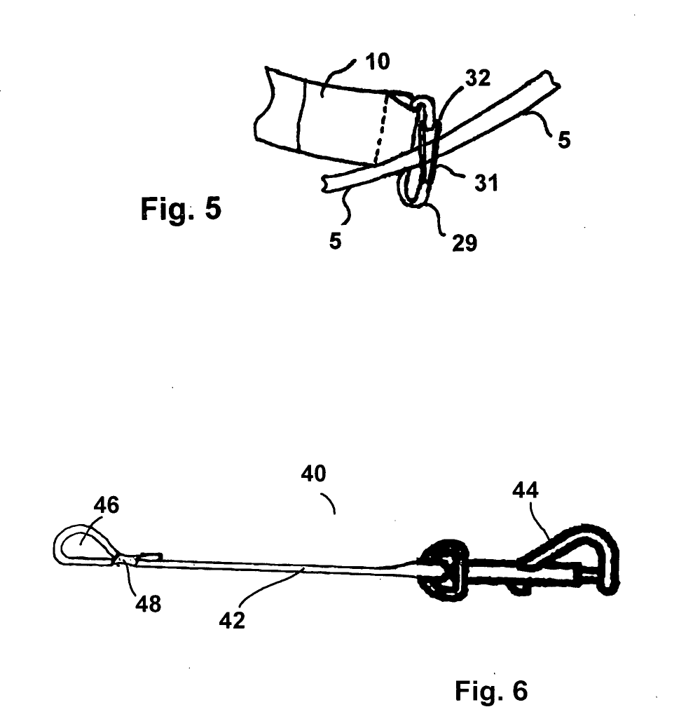

In FIG. 5, ring clasp 29 is shown having an opening and a section 31 which extends across the opening, and which is attached at one end to clasp 29, and, when in a closed position, has a non-attached end 32 which is spring biased to be in contact with a second part of clasp 29 across the ring opening. Pressure can be exerted on the non-attached end 32 of section 31 to temporarily move it away from clasp 29, and thus create an opening into which circular cord 5 can be inserted (or removed). Once circular cord 5 is located within the centre area of clasp 29, section 31 can be allowed to return to a closed position and thus prevent circular cord 5 from leaving the centre of clasp 29.

In the use of the present invention, with respect to the walking of, for example, two dogs, the first fastener 8 is attached to the collar of one dog, and the second fastener 11, is attached to a second dog. As the owner walks the dogs, the owner can release as much of the circular cord 5 as he desires. The circular cord 5 is as long as twenty-five feet but obviously can be made shorter or longer. The range of roaming of the two dogs is dictated by the length of the circular cord 5 released by the owner.

When the owner walks the dogs in areas where distant range or motion would pose a hazard to the animals or others, the owner can retract and/or lock all or a portion of circular cord 5 within body 13, thereby restricting and controlling the range of motion of the animals. When the owner finds himself in an area that affords the animals maximum range of motion, he may allow all of circular cord 5 to be fully released.

Since the key ring 9, or ring clasps 19 or 29, are able to freely slide along circular cord 5, the dogs attached to the first fastener 8 and the second fastener 11 may move independently of one another so long as: i) the circular cord 5 is not fully released; ii) the retractable cord brake 4 is not applied; or iii) the retractable cord lock 3 is not applied.

Preferably, retractable leash I maintains a slight tension on the circular cord 5, and thus first nylon strap 7 and second nylon strap 10, by automatically rewinding the circular cord 5 into the body 13 should there be any slack in circular cord 5. This causes the nylon straps 7, 10 to remain elevated toward the retractable leash I, and assists in preventing tangling of the nylon straps 7, 10. Once either dog moves, the retracting means will release additional circular cord 5 in order to accommodate the moving dog or dogs. Only when the circular cord 5 is fully released may either dog feel a direct effect from each others activities. Of course, if the retractable cord lock 3 or retractable cord brake 4 are applied, the dogs may affect one another.

The first fastener 8 and second fastener 11 may swivel to prevent tangling of the circular cord 5 or the first nylon strap 7 or the second nylon strap 10. Also, the releasable ring might also comprise, or be attached to, additional devices which can also provide the ability to swivel.

The skilled artisan would be well aware that more than one additional leash may be attached to circular cord 5, and thus 3 or more pets may be attached to one leash.

Since the split-ring key ring 9, or the ring clasps 19 or 29, may be easily attached to circular cord 5, the addition of the second leash 14, or more, can be easily accomplished by sliding circular cord 5 through the slot in key ring 9 so that circular cord 5 enters the centre area of key ring 9 or ring clasps 19 or 29. The slot in key ring 9 closes after circular cord 5 has passed through to the centre of key ring 9, or alternatively, the opening in ring clasps 19 or 29 is closed after section 21 is allowed to move back to a closed position.

Removal of key ring 9 or ring clasps 19 or 29, is achieved by a reversal of these steps.

In FIG. 6, a second embodiment of the leash of the present invention is shown wherein the slidable ring structure is a slidable ring formed from a loop of the second leash material. In FIG. 6, a second leash structure 40, is shown comprised of a plastic coated wire cord 42 which has a snaphook 44 at one end. At the other end, the plastic coated wire cord 42 has been looped to form a ring 46, and then held in that position by a wire clamp 48. Ring 46 is formed so as to be large enough for the snaphook 8 and the strap 7 and leash connector 6, from FIG. 1, to pass through ring 46 so that ring 42 is free to slide on retractable cord 5.

Thus, it is apparent that there has been provided, in accordance with the present invention, a leash for multiple pets which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A leash for multiple pets comprising:
a) a retractable leash assembly including:
i) a body having an aperture;
ii) a handle;
iii) a retractable cord having two ends;
iv) one end of the retractable cord connected through the aperture of the body to a retracting means for the retracting and releasing of the retractable cord contained within the body, and the other end of the retractable cord connected to a first leash connector;
v) a first leash having two ends wherein one end is connected to said first leash connector, and the other end is connected to a first fastener;
b) an attachable leash assembly including:
i) a second leash having two ends;
ii) a second fastener attached to one end of said second leash; and
iii) a slidable ring structure for attaching said attachable leash assembly to said retractable cord, and wherein said slidable ring structure is free to slide on said retractable cord.

2. A leash as claimed in claim 1 wherein said slidable ring structure is a releasable ring and said releasable ring is adapted to be releasably connected to said retractable cord of said retractable leash by temporarily moving said releasable ring to an open position to allow said retractable cord to be positioned within an opening in said releasable ring, and subsequently moving said releasable ring to a closed position.

3. A leash as claimed in claim 2 wherein said releasable ring is a split-ring key ring or a spring ring clasp.

4. A leash as claimed in claim 1 wherein said slidable ring has a opening through which said first leash can be inserted.

5. A leash as claimed in claim 4 wherein said slidable ring is formed by creating a loop of said leash at one end of the leash.

6. A leash as claimed in claim 1 wherein said first and/or said second leash is a nylon strap.

7. A leash as claimed in claim 1 further including a retractable cord lock means preventing the retraction or extension of the retractable cord.

8. A leash as claimed in claim 2 wherein said releasable ring has a weight of less than 5 grams.

9. A leash as claimed in claim 1 wherein said first fastener and second fastener swivel.

10. A leash as claimed in claim 1 wherein said first and said second leash are of equal length.

11. An attachable leash assembly for attachment to the retractable cord of a retractable leash, comprising:
i) a leash having two ends;
ii) a fastener attached to one end of said leash; and
iii) a slidable ring structure for attaching said attachable leash assembly to said retractable cord, whereby said slidable ring structure is free to slide on said retractable cord, and wherein said slidable ring structure is not a snaphook.

12. An attachable leash assembly as claimed in claim 11 wherein said releasable ring is adapted to be releasably connected to said retractable cord of said retractable leash by temporarily moving said releasable ring to an open position to allow said retractable cord to be positioned within an opening in said releasable ring, and subsequently moving said releasable ring to a closed position.

13. An attachable leash assembly as claimed in claim 12 wherein said releasable ring is a split-ring key ring, or a spring ring clasp.

14. An attachable leash assembly as claimed in claim 11 wherein said slidable ring is formed by creating a loop of said leash at one end of the leash.

15. An attachable leash assembly as claimed in claim 14 wherein said slidable ring has an opening through which a leash of a retractable leash can be inserted.
